(19) United States
(12) Patent Application Publication
(10) Pub. No.: US 2012/0066082 A1
(43) Pub. Date: Mar. 15, 2012

(54) SOCIAL MEDIA CAMPAIGN SYSTEM

(76) Inventor: STEPHEN SADLER, Clarkston, MI (US)

(21) Appl. No.: 13/152,148

(22) Filed: Jun. 2, 2011

Related U.S. Application Data
(60) Provisional application No. 61/350,720, filed on Jun. 2, 2010.

(51) Int. Cl. G06F 15/16; G06Q 30/06

(52) U.S. Cl. 705/26.1; 709/204

(57) ABSTRACT

A social media campaign system is described that can quickly and efficiently develop, manage and/or coordinate several different marketing and/or sales campaigns on numerous social media outlets. The system enables the user to upload (especially on a “bulk” basis), schedule and release “tweets” or other content in a highly quick and efficient manner. The user can create, upload, schedule and broadcast a large number of individual marketing and/or sales campaigns on a large number of different social media outlets or networks that has heretofore been too difficult, laborious and time consuming to accomplish with conventional means.

### CROSS-REFERENCE TO RELATED APPLICATION

The instant application claims priority to U.S. Provisional Patent Application Ser. No. 61/350,720 filed Jun. 2, 2010, pending, the entire specification of which is expressly incorporated herein by reference.

### FIELD OF THE INVENTION

The present invention relates generally to social media systems and, more specifically, to social media campaign systems that can quickly and efficiently develop, manage and/or coordinate several different marketing and/or sales campaigns on numerous social media outlets.

### BACKGROUND OF THE INVENTION

Social media are media designed to be disseminated through social interaction, using highly accessible and scalable publishing techniques. Social media typically use Web-based technologies to transform and broadcast media monologues into social media dialogues. Social media have been modernized to reach consumers through the Internet, and, as a result, have become appealing to big and small businesses alike. For example, consumer brands are utilizing social media to reach customers and to build and/or maintain their reputations. As social media continue to grow, the ability to reach more consumers globally has also increased. Accordingly, social media have become one of the newest tools for effective business marketing and sales efforts.

Social media are distinct from industrial or traditional media, such as newspapers, television, and film in that they are relatively inexpensive and accessible to enable anyone (even private individuals) to very quickly (e.g., essentially real-time) publish or access information, compared to industrial media, which generally require significant time (e.g., days, weeks or even months) and resources to publish information. One example of such a social media content piece is generally referred to as a “tweet,” “status update,” “post,” “text,” “message” and/or the like. For purposes of brevity and simplicity, the social media content pieces discussed herein will be referred to as “tweets.”

Social media can take many different forms, including Internet forums, weblogs, social blogs, microblogging, wikis, podcasts, pictures, video, rating and social bookmarking. Technologies include: blogs, picture-sharing, vlogs, wall-postings, email, instant messaging, music-sharing, crowdsourcing, and voice over IP, to name a few. Many of these social media services can be integrated via social network aggregation platforms like Plugged.it, Mybloglog and Plaxo.

Examples of social media software applications include: (1) communication (e.g., Blogs: Blogger, LiveJournal, Open Diary, TypePad, WordPress, Vox, ExpressionEngine, Xanga, and/or the like); (2) micro-blogging/presence applications (e.g., FMyLife, Jaiku, Plurk, Twitter, Tumblr, Posterous, Yammer, Qaiku, and/or the like); (3) social networking: (e.g., Facebook, Geni.com, Hi5, LinkedIn, MySpace, Ning, Orkut, Skyrock, Qzone, Vkontakte, RenRen, Kaixin, ASmallWorld, studivz, Xing, RunAlong.se, Bebo, BigTent, Elgg, Hyves, Flirtomatic, and/or the like); (4) social network aggregation (e.g., NutshellMail, FriendFeed, dillidost.com, and/or the like); (5) events (e.g., Upcoming, Eventful, Meetup.com, and/or the like); and (6) information aggregators (e.g., Netvibes, Twine, and/or the like).

However, the ability to quickly and efficiently develop, manage and/or coordinate several different marketing and/or sales campaigns on numerous social media outlets (generally defined as any type of social networking sites, social media sharing sites, search engines, and/or mobile applications and/or devices, and/or the like) has to date been extremely difficult, laborious and time consuming.

Therefore, it would be advantageous to provide a new and improved social media campaign system that overcomes at least one of the aforementioned problems.

### SUMMARY OF THE INVENTION

In accordance with the general teachings of the present invention, a new and improved social media campaign system is provided that can quickly and efficiently develop, manage and/or coordinate several marketing and/or sales campaigns on numerous social media outlets.

One of the primary advantages of the present invention is that it enables the user to upload (especially on a “bulk” basis), schedule and release “tweets” or other content in a highly quick and efficient manner. That is, by accessing the appropriate web page featuring one of the aspects of the present invention, the user can create, upload, schedule and broadcast a large number of individual marketing and/or sales campaigns on a large number of different social media outlets or networks that has heretofore been too difficult, laborious and time consuming to accomplish with conventional means.

In accordance with a first embodiment of the present invention, a new and improved social media campaign system is provided, comprising:

a data storage system;

a data input system operably associated with the data storage system; and

a data transmission system operably associated with the data storage system;

wherein the data input system is selectively operable to input a piece of social media content to the data storage system;

wherein the data transmission system is selectively operable to transmit the piece of social media content from the data storage system to a social media outlet.

In accordance with one aspect of this embodiment, the social media campaign system further comprises a display system operably associated with the data storage system.

In accordance with one aspect of this embodiment, the piece of social media content includes a body portion and a prefix portion, wherein a plurality of prefix portions are assembled with a plurality of body portions to produce a plurality of pieces of social media content.

In accordance with one aspect of this embodiment, the social media campaign system further comprises a social media campaign management system operably associated with the data storage system.

In accordance with one aspect of this embodiment, the social media campaign management system is selectively operable to permit a user to perform a function selected from the group consisting of adding social media networks, adding social media campaigns, editing social media campaigns, accessing social media campaign tools, and combinations thereof.

In accordance with one aspect of this embodiment, a broadcast frequency can be selected for the data transmission system so as to control the broadcast frequency of the piece of social media content.

In accordance with one aspect of this embodiment, a broadcast sequence can be selected for the data transmission system so as to control the broadcast sequence of the piece of social media content.

In accordance with one aspect of this embodiment, the social media campaign system further comprises a payment system operably associated with the social media campaign management system, wherein the payment system is selectively operable to accept or process payments on the basis of a pay-per-piece of social media content.

In accordance with one aspect of this embodiment, the social media campaign system further comprises a pause system operably associated with the social media campaign management system, wherein the pause system is selectively operable to pause the social media campaign.

In accordance with one aspect of this embodiment, the social media campaign system further comprises a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof.

In accordance with one aspect of this embodiment, the piece of social media content is contained in a comma separated value file format.

In accordance with a second embodiment of the present invention, a new and improved social media campaign system is provided, comprising:

a data storage system;

a data input system operably associated with the data storage system;

a data transmission system operably associated with the data storage system; and

a social media campaign management system operably associated with the data storage system;

wherein the data input system is selectively operable to input a piece of social media content to the data storage system;

wherein the data transmission system is selectively operable to transmit the piece of social media content from the data storage system to a social media outlet;

wherein the social media campaign management system is selectively operable to permit a user to perform a function selected from the group consisting of adding social media networks, adding social media campaigns, editing social media campaigns, accessing social media campaign tools, and combinations thereof.

In accordance with one aspect of this embodiment, the social media campaign system further comprises a display system operably associated with the data storage system.

In accordance with one aspect of this embodiment, a broadcast frequency or sequence can be selected for the data transmission system so as to control the broadcast frequency or sequence of the piece of social media content.

In accordance with one aspect of this embodiment, the social media campaign system further comprises a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof.

In accordance with one aspect of this embodiment, the piece of social media content is contained in a comma separated value file format.

In accordance with one aspect of this embodiment, the piece of social media content includes a body portion and a prefix portion, wherein a plurality of prefix portions are assembled with a plurality of body portions to produce a plurality of pieces of social media content.

In accordance with a third embodiment of the present invention, a new and improved social media campaign system is provided, comprising:

a data storage system;

a data input system operably associated with the data storage system;

a data transmission system operably associated with the data storage system;

a display system operably associated with the data storage system;

a social media campaign management system operably associated with the data storage system; and

a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof;

wherein the data input system is selectively operable to input a piece of social media content to the data storage system;

wherein the data transmission system is selectively operable to transmit the piece of social media content from the data storage system to a social media outlet;

wherein the social media campaign management system is selectively operable to permit a user to perform a function selected from the group consisting of adding social media networks, adding social media campaigns, editing social media campaigns, accessing social media campaign tools, and combinations thereof;

wherein the piece of social media content includes a body portion and a prefix portion, wherein a plurality of prefix portions are assembled with a plurality of body portions to produce a plurality of pieces of social media content.

In accordance with one aspect of this embodiment, a broadcast frequency or sequence can be selected for the data transmission system so as to control the broadcast frequency or sequence of the piece of social media content.

In accordance with one aspect of this embodiment, the piece of social media content is contained in a comma separated value file format.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a flowchart illustrating an exemplary social media campaign system, in accordance with a first embodiment of the present invention;

FIG. 2 is a screen capture of a main login page of a website hosting a social media campaign system, in accordance with a second embodiment of the present invention;

FIG. 3 is a screen capture of an account page of a website hosting a social media campaign system, in accordance with a third embodiment of the present invention;

FIG. 4 is a screen capture of a campaign account page of a website hosting a social media campaign system, in accordance with a fourth embodiment of the present invention;

FIG. 5 is a screen capture of an add/edit campaign page of a website hosting a social media campaign system, in accordance with a fifth embodiment of the present invention; and

FIG. 6 is a screen capture of a play/monitor page of a website hosting a social media campaign system, in accordance with a sixth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

In order to fully appreciate the benefits and features of the systems of the present invention, it is assumed that an individual practicing the present invention will preferably have: access to a computer (and is conversant with the basic functions thereof); an Internet service provider (“ISP”) (e.g., AOL, AT&T, COMCAST, NETZERO and/or the like) preferably with e-mail capability; a Web browser (e.g., GOOGLE CHROME, MOZILLA FIREFOX, WINDOWS INTERNET EXPLORER, APPLE SAFARI or the like); any required plug-ins (e.g., ADOBE FLASH PLAYER, ADOBE SHOCKWAVE, APPLE QUICKTIME, JAVA VIRTUAL MACHINE, and/or the like); and have the ability to navigate successfully to any given uniform resource locator (“URL”).

It should be appreciated that the systems of the present invention can be practiced in conjunction with the Internet, World Wide Web, intranets, extranets, cloud computing, electronic media (e.g., CD/DVD-based systems), or the like, and can be accessed by any type of portable and/or wireless computer and/or communication device, including but not limited to laptop computers, netbook computers, tablet computers, hand held computers, smart phones, personal digital assistants, portable media players, cell phones, and/or the like. Alternatively, the systems of the present invention can be directly loaded onto stand-alone computer workstations. Although the systems of the present invention will refer generally to software program(s) that have primary application to social media, it should be appreciated that this is for illustrative purposes only, and that the present invention can be practiced with any type of subject matter.

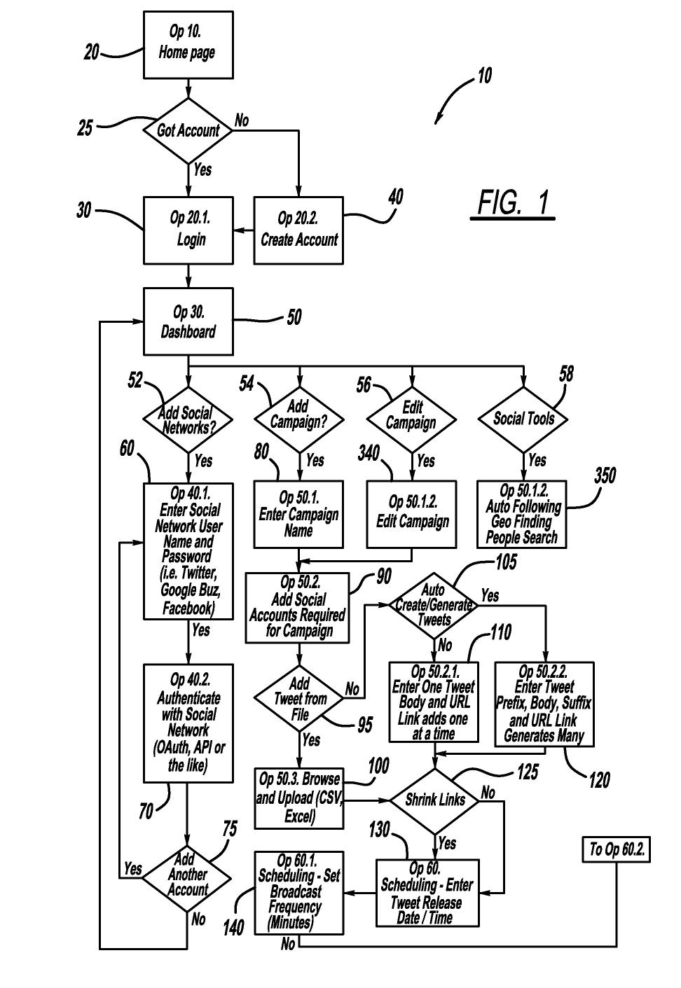

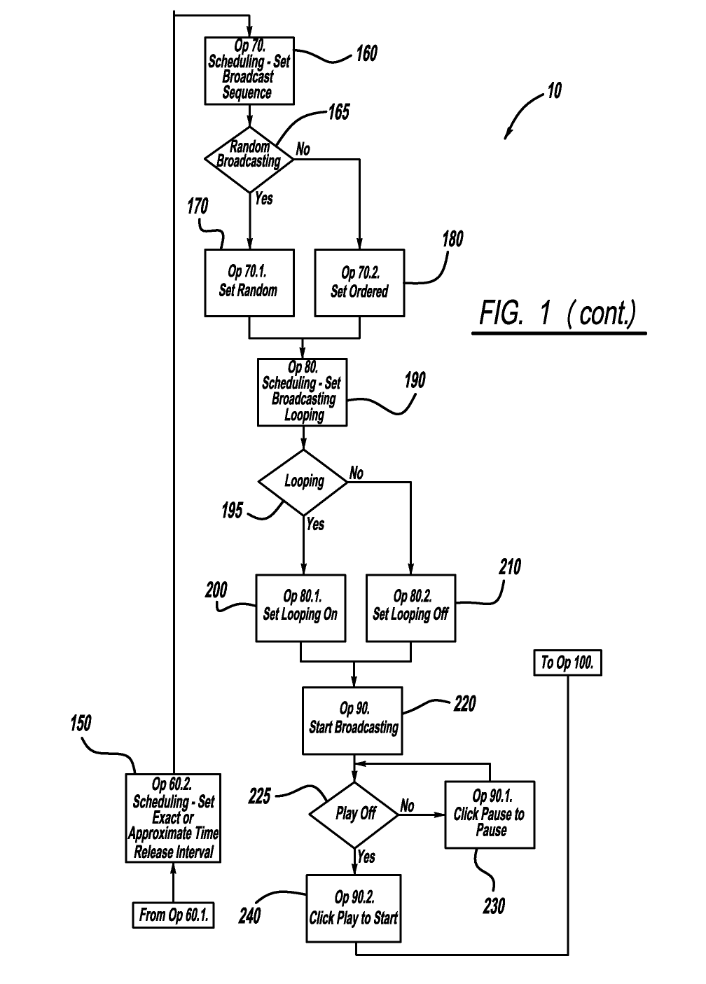

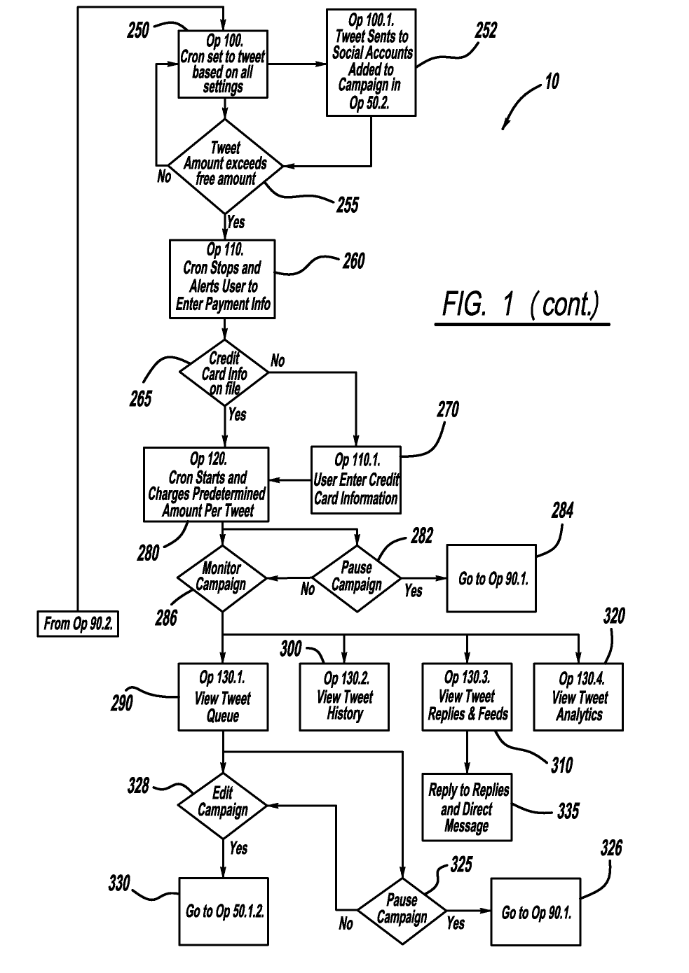

Referring to FIG. 1, there is shown a flowchart illustrating an exemplary social media campaign system generally at 10, in accordance with a first embodiment of the present invention. As previously noted, it is assumed that the user has access to a computer and/or communication device (e.g., wired or wireless) that is able to view (e.g., through a screen and/or other viewing device) and interact (e.g., through a mouse, stylus, keyboard, and/or the like) with the system 10 of the present invention.

In this view, the user may, for example, navigate to the URL of the main Web Site that contains the system 10 (e.g., with the aid of a Web browser) and view same on any suitable display system (e.g., a screen and/or other viewing device). By way of a non-limiting example, the system 10 may be embodied in one or more software programs that are contained on one or more computers (e.g., servers) or other data storage systems. In this case, the user may navigate to the home page of the website hosting the system 10 (e.g., see Operation (hereinafter abbreviated as “Op.”) 10 generally at 20). It should be noted that one or more of the “operations” described herein may be optional or may be performed in an alternative order or sequence than that described herein.

By way of a non-limiting example, the URL http://burtweet.com may be designated as the main Web Site for the system 10. Once this URL is accessed, clear instructions may be available on navigating to the exact invention page. Once accessed, it may cause a graphical movie screen (e.g., FLASH, SHOCKWAVE, JAVA, HTML or the like) to be displayed as a result of an action within the HyperText Markup Language (“HTML”) Web interface file (e.g., written with the aid of a programming language, such as but not limited to JavaScript), thus letting the individual know that he or she has arrived at the correct system Web Site. It should be appreciated that the user will occasionally be required to click on various links in order to navigate to various portions of the Web Site.

The user may then be queried generally at 25 whether they have an account. The user may then prompted to enter (e.g., via any suitable data input system, such as but not limited to a mouse, stylus, keyboard, and/or the like) their login information (e.g., see Op. 20.1 generally at 30), presuming that the user has already created an account. By way of a non-limiting example, the login information can include, without limitation, a user name, a password and/or the like. If the user has not already created an account, they will be prompted to create an account (e.g., see Op. 20.2 generally at 40).

Once the login process has been completed, the user may then be brought to a “dashboard” or account page (e.g., see Op. 30 generally at 50) that provides a social media campaign management system and/or function. At the account page, the user can choose from several different options including but not limited to queries to: (1) add social (media) networks generally at 52; (2) add campaigns generally at 54; (3) edit campaigns generally at 56; and/or (4) access social (media) tools generally at 58.

If the user chooses the “add social (media) networks” option, the user may then be prompted to enter a social (media) network user name and password (e.g., see Op. 40.1 generally at 60). Once, the requested information is entered by the user, the information may be authenticated with the corresponding social (media) network(s) (e.g., see Op. 40.2 generally at 70). The user may then be queried generally at 75 whether they want to add another account. If the answer is yes, the user may then be directed back to Op. 40.1. If the answer is no, the user may then be directed back to Op. 30.

If the user chooses the “add campaign” option, the user may be prompted to enter a campaign name (e.g., see Op. 50.1 generally at 80). Once, the campaign name is entered by the user, the social (media) accounts required for the campaign are provided by the user (e.g., see Op. 50.2 generally at 90). At this point, the user may be queried generally at 95 whether they want to add any “tweets” or other content, from any number of various content files. If the answer is yes, the user may browse the files from a computer or other data storage system and upload the appropriate file(s) (e.g., see Op. 50.3 generally at 100) to the system's 10 computer (e.g., server) or other data storage system. If the answer is no, the user may be queried generally at 105 whether they want to auto create or generate any “tweets” or other content. If the answer is no, the user may enter one “tweet” body and URL link (e.g., see Op. 50.2.1 generally at 110). If the answer is yes, the user may enter the “tweet” prefix, body, suffix and URL link (e.g., see Op. 50.2.2 generally at 120).

At this point, the user may be queried generally at 125 whether they want to shrink links, i.e., shorten long and hard to remember URLs into shorter and easier to remember URLs. If the answer is either yes or no, the user may enter the scheduling information, such as the “tweet” release date and/or time (e.g., see Op. 60 generally at 130). The user may then be prompted to enter additional scheduling information, such as the broadcast frequency (e.g., in terms of minutes) (e.g., see Op. 60.1 generally at 140). If the answer is no, the user may then be prompted to set an exact or approximate time release interval (e.g., see Op. 60.2 generally at 150).

If the answer is still no, the user may be prompted to set a broadcast sequence (e.g., see Op. 70 generally at 160). At this point, the user may be queried generally at 165 whether to use random broadcasting. If the answer is yes, random broadcasting may be set (e.g., see Op. 70.1 generally at 170). If the answer is no, ordered broadcasting may be set (e.g., see Op. 70.2 generally at 180). At this point, the user may be prompted to set the broadcast looping (e.g., see Op. 80 generally at 190) and queried generally at 195. If the answer is yes, the user may set the looping on (e.g., see Op. 80.1 generally at 200). If the answer is no, the user may set the looping off (e.g., see Op. 80.2 generally at 210). This function may also be automated, thus negating the need for the user to make a decision.

At this point, the user may start broadcasting (e.g., see Op. 90 generally at 220) or sending the “tweet” or other content out to one or more different social media outlets or networks, e.g., as part of a marketing and/or sales campaign. The broadcasting may be accomplished through a data transmission system that interoperates with the system 10, such as but not limited to wired (e.g., via cable transmission, telephone wire transmission, fiber optic transmission, and/or the like) and/or wireless (e.g., via radio wave transmission, microwave transmission and/or the like) data transmission systems. The user may be queried generally at 225 whether the play function is off. If the answer is no, the user may click a pause key to pause the broadcast (e.g., see Op. 90.1 generally at 230), e.g., to edit the content of the campaign. If the answer is yes, the user may click a play key to start the broadcast (e.g., see Op. 90.2 generally at 240).

At this point, a chronometer control may be set to transmit the “tweet” or other content based on all of the aforementioned scheduling settings (e.g., see Op. 100 generally at 250). At this point, the “tweet” or other content may be sent to the social media accounts added to the campaign in Op. 50.2 (e.g., see Op. 100.1 generally at 252). The user may be queried generally at 255 whether the “tweet” or other content exceeds the free amount. If the answer is no, the user may be directed back to Op. 100. If the answer is yes, the chronometer control may stop and alert the user to enter payment information (e.g., see Op. 110 generally at 260). The user may then be queried generally at 265 whether their payment information (e.g., credit card information) is stored on file. If the answer is no, the user may be prompted to enter their payment information (e.g., see Op. 110.1 generally at 270). If the answer is yes, the chronometer control may start and charge a pre-determined amount per “tweet” (e.g., see Op. 120 generally at 280).

At this point, the user may be queried generally at 282 as to whether they want to pause the campaign. If the pause option is chosen, the user may be directed back to Op. 90.1 generally at 284. If the pause option is declined, the user may be queried generally at 286 as to whether they want to monitor the campaign.

At this point, the user has several options, including: (1) viewing the “tweet” queue (e.g., see Op. 130.1 generally at 290); (2) viewing the “tweet” history (e.g., see Op. 130.2 generally at 300); (3) viewing the “tweet” replies and feeds (e.g., see Op. 130.3 generally at 310); and/or (4) viewing the “tweet” analytics (e.g., see Op. 130.4 generally at 320).

If the user chooses to view the view “tweet” queue option, they may then be queried generally at 325 as to whether they want to pause the campaign. If the answer is yes, the user may be directed back to Op. 90.1 generally at 326. If the answer is no, the user may be queried generally at 328 whether they want to edit the campaign. If the answer is yes, the user may be directed back to Op. 90.1.2 generally at 330.

If the user chooses the “view tweet replies and feeds” option, they may then reply to the replies and direct messages generally at 335.

If the user chooses the “edit campaign” option, the user may then be prompted to edit the campaign (e.g., see Op. 50.1.2 generally at 340). At this point, the user may be directed back to Op. 50.2.

If the user chooses the “social tools” option, the user may be directed to various social (media) tool websites, such as Auto Following, Geo Finding, People Search, and/or the like (e.g., see Op. 50.1.3 generally at 350).

One of the primary advantages of the present invention is that it enables the user to upload (especially on a “bulk” basis), schedule and release “tweets” or other content in a highly quick and efficient manner. That is, by accessing the appropriate web page featuring one of the aspects of the present invention, the user can create, upload, schedule and broadcast a large number of individual marketing and/or sales campaigns on a large number of different social media outlets or networks that has heretofore been too difficult, laborious and time consuming to accomplish with conventional means. Furthermore, as the “tweet” files are generally comprised of various components, such as but not limited to body (or subject) portions as well as prefix portions, it is possible to generate lists of these body and prefix portions that can be assembled together into a plurality or multiplicity of possible combinations to produce an enormous number of “tweets” with relatively little effort and expense.

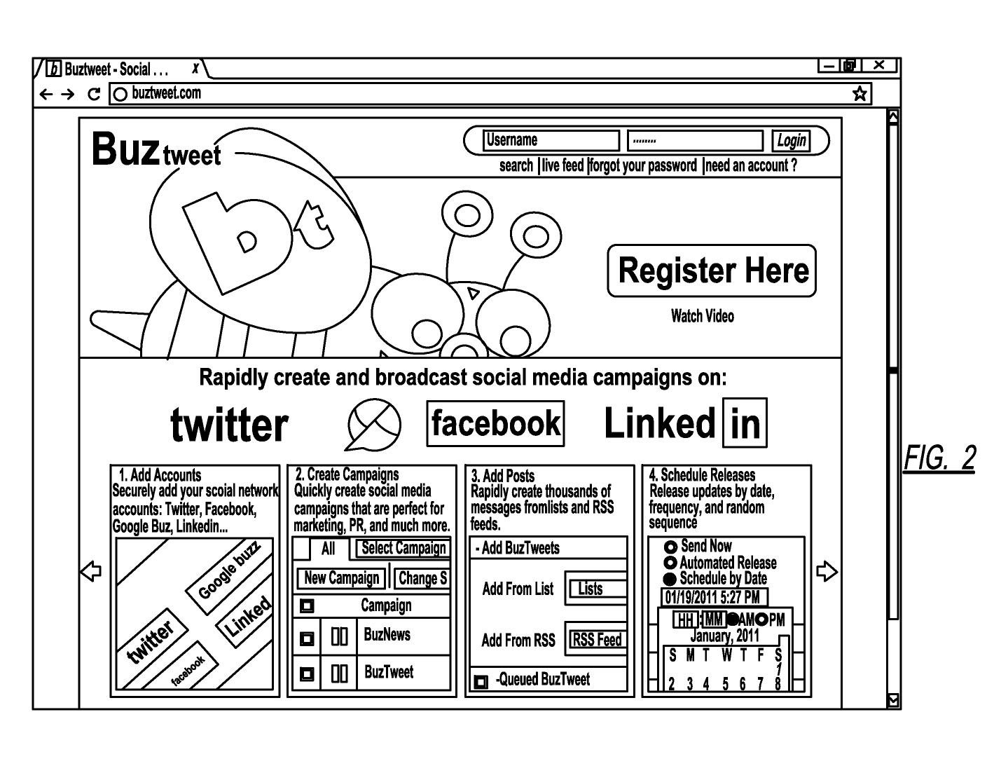

Referring to FIG. 2, there is shown a screen capture of a main login page of a website hosting a social media campaign system, in accordance with a second embodiment of the present invention. In this view, the user may be introduced to the general attributes of the system, such as but not limited to the ability of the user to create social media campaigns by: (1) adding updates; (2) scheduling releases; (3) posting to social (media) sites; and/or (4) tracking performance. A “start here” button permits the user to access the functional aspects of the system 10.

Referring to FIG. 3, there is shown a screen capture of an account page of a website hosting a social media campaign system, in accordance with a third embodiment of the present invention. In this view, the user may view their existing social media accounts, as well as add new social media accounts. The social media accounts may be labeled by account name and/or account type. It should be appreciated that it is envisioned that other types of labeling parameters may be added and/or created, e.g., by the administrator of the system and/or by the individual user. Also in this view, it can be seen that the hypothetical user has multiple account names and social media accounts with a wide variety of different social media campaign types (e.g., TWITTER, FACEBOOK, LINKEDIN and GOOGLE BUZZ).

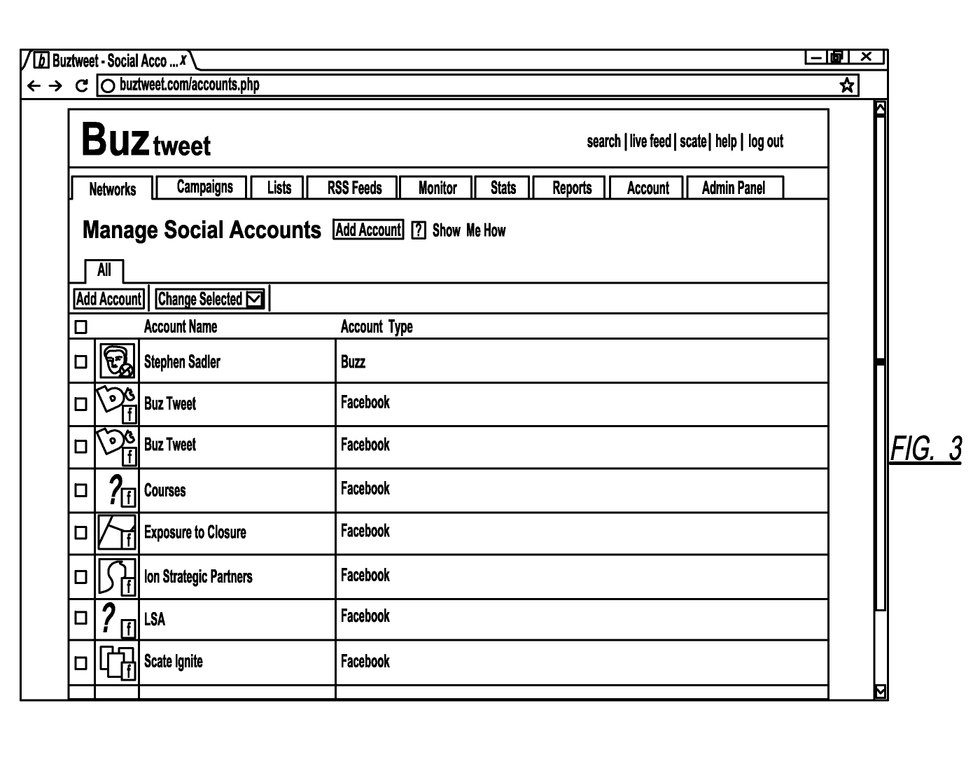

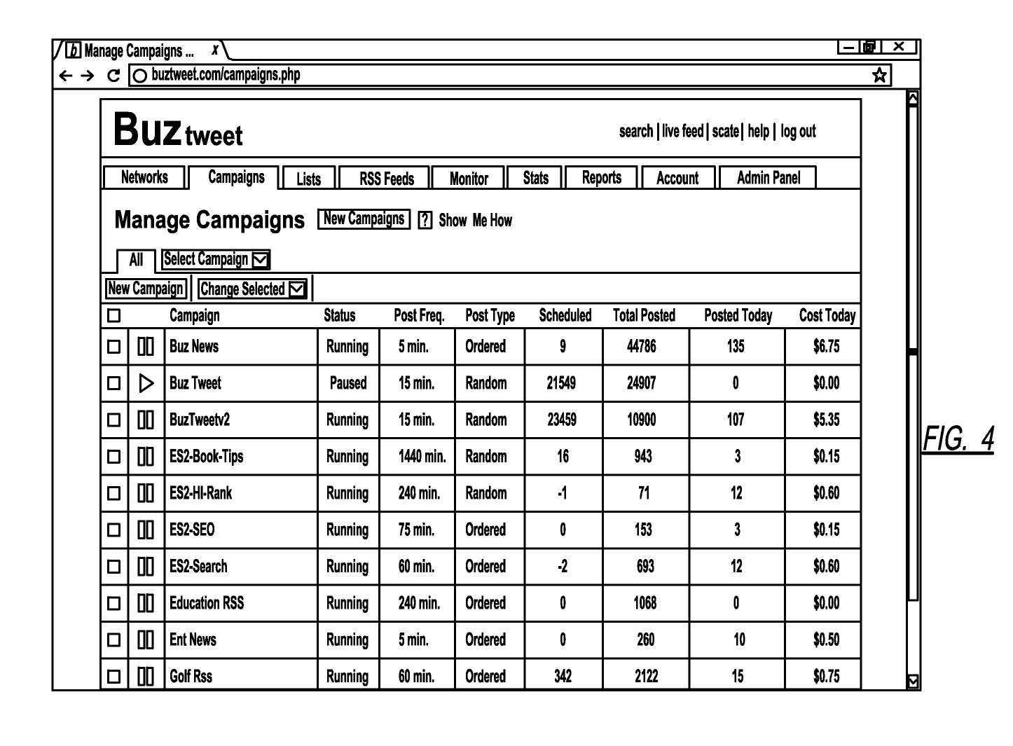

Referring to FIG. 4, there is shown a screen capture of a campaign account page of a website hosting a social media campaign system, in accordance with a fourth embodiment of the present invention. In this view, the user may view their existing social media campaigns in a convenient and easy to understand report system or format. The social media campaigns may be labeled, without limitation, by: (1) campaign name; (2) status; (3) post frequency; (4) number scheduled; (5) number posted; (6) average cost per thousand (CPT); (7) cost; (8) post type; (9) number of clicks per piece of social media content; (10) number of clicks per prefix of piece of social media content; (11) number of clicks per body of piece of social media content; (12) number of clicks per geographic origin location; and/or the like. It should be appreciated that it is envisioned that other types of labeling parameters may be added and/or created, e.g., by the administrator of the system and/or by the individual user. Also in this view, it can be seen that the hypothetical user may monitor multiple social media campaigns on a single screen. If there are several screens of multiple social media campaigns, the user may simply and easily scroll through several screens to view all of his or her social media campaigns. Thus, a single user may view and manage dozens, hundreds, or even thousands of social media campaigns in one convenient location and format.

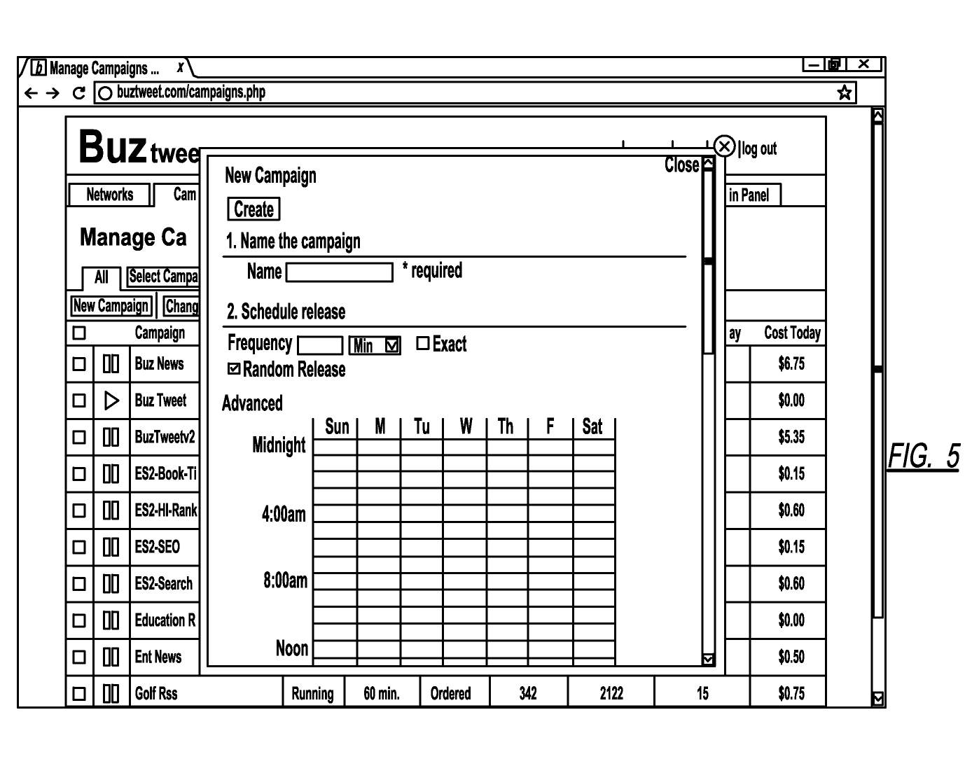

Referring to FIG. 5, there is shown a screen capture of an add/edit campaign page of a website hosting a social media campaign system, in accordance with a fifth embodiment of the present invention. In this view, a new social media campaign may be created by the user. By way of a non-limiting example, additional ‘tweets” (e.g., in the form of CSV (i.e., comma separated value) format files) or other content may be added to existing campaigns. Additionally, the existing campaigns may be edited or modified on a number of different parameters. In this manner, the user can quickly and easily add updates and schedule releases to his or her existing or new social media campaigns as circumstances require.

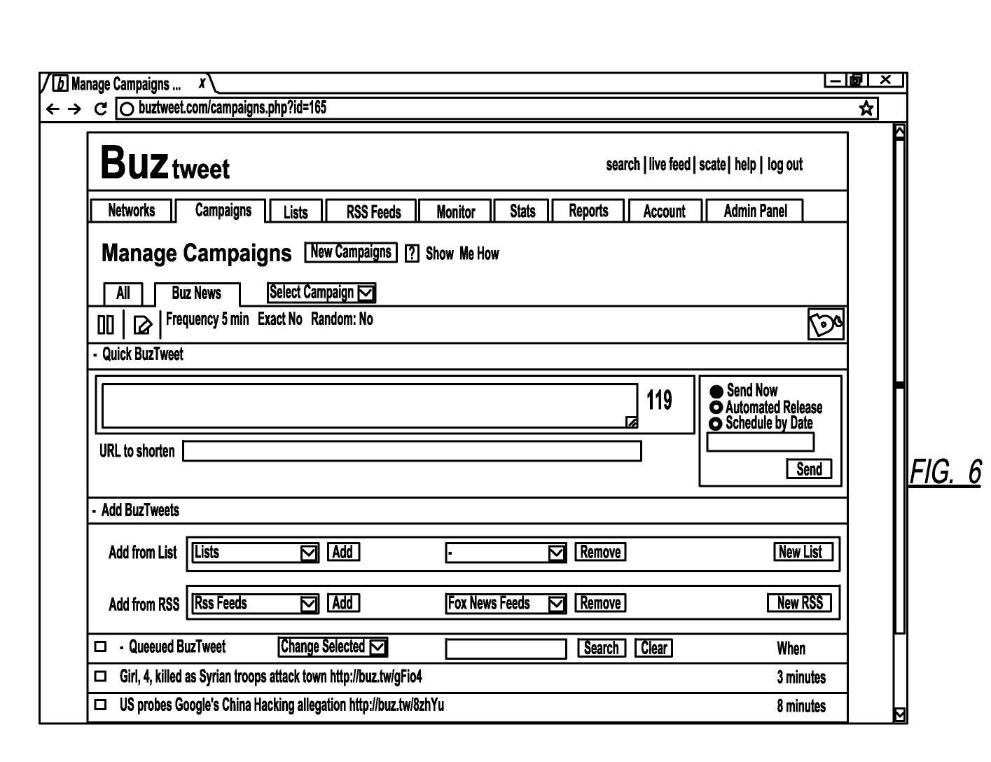

Referring to FIG. 6, there is shown a screen capture of a play/monitor page of a website hosting a social media campaign system, in accordance with a sixth embodiment of the present invention. In this view, the user can track, by title/name (including the URL) and frequency (e.g., by number of minutes), his or her existing social media campaigns.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A social media campaign system, comprising:
a data storage system;
a data input system operably associated with the data storage system; and
a data transmission system operably associated with the data storage system;
wherein the data input system is selectively operable to input a piece of social media content to the data storage system;
wherein the data transmission system is selectively operable to transmit the piece of social media content from the data storage system to a social media outlet.

2. The social media campaign system according to claim 1, further comprising a display system operably associated with the data storage system.

3. The social media campaign system according to claim 1, wherein the piece of social media content includes a body portion and a prefix portion, wherein a plurality of prefix portions are assembled with a plurality of body portions to produce a plurality of pieces of social media content.

4. The social media campaign system according to claim 1, further comprising a social media campaign management system operably associated with the data storage system.

5. The social media campaign system according to claim 4, wherein the social media campaign management system is selectively operable to permit a user to perform a function selected from the group consisting of adding social media networks, adding social media campaigns, editing social media campaigns, accessing social media campaign tools, and combinations thereof.

6. The social media campaign system according to claim 4, wherein a broadcast frequency can be selected for the data transmission system so as to control the broadcast frequency of the piece of social media content.

7. The social media campaign system according to claim 4, wherein a broadcast sequence can be selected for the data transmission system so as to control the broadcast sequence of the piece of social media content.

8. The social media campaign system according to claim 4, further comprising a payment system operably associated with the social media campaign management system, wherein the payment system is selectively operable to accept or process payments on the basis of a pay-per-piece of social media content.

9. The social media campaign system according to claim 4, further comprising a pause system operably associated with the social media campaign management system, wherein the pause system is selectively operable to pause the social media campaign.

10. The social media campaign system according to claim 4, further comprising a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof.

11. The social media campaign system according to claim 1, wherein the piece of social media content is contained in a comma separated value file format.

12. A social media campaign system, comprising:
a data storage system;
a data input system operably associated with the data storage system;
a data transmission system operably associated with the data storage system; and
a social media campaign management system operably associated with the data storage system;
wherein the data input system is selectively operable to input a piece of social media content to the data storage system;
wherein the data transmission system is selectively operable to transmit the piece of social media content from the data storage system to a social media outlet;
wherein the social media campaign management system is selectively operable to permit a user to perform a function selected from the group consisting of adding social media networks, adding social media campaigns, editing social media campaigns, accessing social media campaign tools, and combinations thereof.

13. The social media campaign system according to claim 12, further comprising a display system operably associated with the data storage system.

14. The social media campaign system according to claim 12, wherein a broadcast frequency or sequence can be selected for the data transmission system so as to control the broadcast frequency or sequence of the piece of social media content.

15. The social media campaign system according to claim 12, further comprising a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof.

16. The social media campaign system according to claim 12, wherein the piece of social media content is contained in a comma separated value file format.

17. The social media campaign system according to claim 12, wherein the piece of social media content includes a body portion and a prefix portion, wherein a plurality of prefix portions are assembled with a plurality of body portions to produce a plurality of pieces of social media content.

18. A social media campaign system, comprising:
a data storage system;
a data input system operably associated with the data storage system;
a data transmission system operably associated with the data storage system;
a display system operably associated with the data storage system;
a social media campaign management system operably associated with the data storage system; and
a report system operably associated with the social media campaign management system, wherein the report system is selectively operable to display a parameter of the social media campaign selected from the group consisting of social media campaign name, social media campaign status, social media campaign post frequency, social media campaign posts scheduled, social media campaign posts posted, social media campaign average cost per thousand posts, total social media campaign cost, social media campaign post type, number of clicks per piece of social media content, number of clicks per prefix of piece of social media content, number of clicks per body of piece of social media content, number of clicks per geographic origin location, and combinations thereof;
wherein the data input system is selectively operable to input a piece of social media content to the data storage system;
wherein the data transmission system is selectively operable to transmit the piece of social media content from the data storage system to a social media outlet;
wherein the social media campaign management system is selectively operable to permit a user to perform a function selected from the group consisting of adding social media networks, adding social media campaigns, editing social media campaigns, accessing social media campaign tools, and combinations thereof;
wherein the piece of social media content includes a body portion and a prefix portion, wherein a plurality of prefix portions are assembled with a plurality of body portions to produce a plurality of pieces of social media content.

19. The social media campaign system according to claim 18, wherein a broadcast frequency or sequence can be selected for the data transmission system so as to control the broadcast frequency or sequence of the piece of social media content.

20. The social media campaign system according to claim 18, wherein the piece of social media content is contained in a comma separated value file format.
